(19) United States
(12) Patent Application Publication
(10) Pub. No.: US 2007/0070376 A1
(43) Pub. Date: Mar. 29, 2007

(54) Systems and methods for load balancing the creation of raster data and page description language data on a host

(75) Inventors: James E. Owen, Vancouver, WA (US); Kerry R. Calvert, Portland, OR (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/233,286

(22) Filed: Sep. 22, 2005

(51) Int. Cl. G06F 3/12

(52) U.S. Cl. 358/1.13; 358/1.15

(57) ABSTRACT

In an exemplary method, a print server receives a request from a host for instructions regarding how to process graphics commands corresponding to a print job. In response, the print server determines whether raster image processing of the graphics commands is more efficiently performed by a raster image processing unit on the host or by one or more other raster image processing units. If the print server determines that the raster image processing is more efficiently performed by the host's raster image processing unit, the print server instructs the host to rasterize the graphics commands. If the print server determines that the raster image processing is more efficiently performed by the one or more other raster image processing units, the print server instructs the host to render the graphics commands into page description language data.

### TECHNICAL FIELD

The present invention relates generally to computers and computer-related technology. More specifically, the present invention relates to systems and methods for load balancing the creation of raster data and page description language data on a host.

### BACKGROUND

There are many different kinds of computers in use today. The term “computer system” will be used herein to refer generally to any device or combination of devices that is capable of processing information to produce a desired result. Some examples of computer systems include personal computers, hand-held computers, personal digital assistants (PDAs), servers, mainframes, supercomputers, minicomputers, workstations, microcomputers, microcontrollers, and the like.

Document printing is a familiar task to many computer users. The term “printing device,” as used herein, refers to any device that produces human-readable text and/or graphics on an output medium, such as paper. Some examples of printing devices include computer printers, fax machines, scanners, multi-function peripherals, copiers, and so forth.

In some contexts, a computer system may be referred to as a host. To facilitate communication between a host and a printing device, the host may include a driver for the printing device. The driver for a particular printing device allows applications on the host to be able to communicate with the printing device without knowing specific details about the printing device's hardware and internal language.

One or more printing devices may be connected to a computer network. This allows the various computer systems on the network to send print jobs to the printing device(s). A print job is a single document or a set of documents that is submitted to a printing device for printing.

Raster image processing (RIP) is the process of converting text and images into the matrix of pixels (bitmap) that is ultimately printed on paper by a printing device. An RIP unit performs raster image processing. An RIP unit may be implemented using hardware and/or software components. The term “rasterization” refers to the process of performing raster image processing.

When a print job is created on a host, the host may rasterize (i.e., perform raster image processing on) the print job, thereby creating raster data. The host may then send the raster data to a printing device. Alternatively, the host may generate a description of the print job using a page description language (PDL). PDLs may be used to specify the arrangement of a printed page. PDLs define page elements independently of printer technology, so that a page's appearance remains consistent regardless of the specific printing device that is used. Some examples of PDLs include the Printer Control Language (PCL), PostScript, etc. Where the host describes the print job using a PDL, raster image processing may be performed by an RIP unit that is located elsewhere, such as on a printing device or on a dedicated RIP server.

Under some circumstances, it may be more efficient for the host to rasterize a print job (or a portion thereof) and send raster data to the printing device. However, under other circumstances, it may be more efficient for the host to render a print job into PDL commands and send those PDL commands elsewhere for rasterization. Accordingly, benefits may be realized by improved systems and methods for load balancing the creation of raster data and PDL data on the host. Some exemplary systems and methods for load balancing the creation of raster data and PDL data on the host are described herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram that illustrates some components in an embodiment of a system for load balancing the raster image processing of a print job, including a host that is in electronic communication with a print server that comprises a raster image processing (RIP) control unit;

FIG. 2 illustrates the operation of the RIP control unit in some embodiments;

FIG. 3 illustrates some exemplary components and/or information that may be included in and/or utilized by the RIP control unit in some embodiments;

FIG. 4 illustrates some exemplary components that may be included in the host in some embodiments;

FIG. 5 illustrates how graphics commands that correspond to a print job may be processed in some embodiments;

FIG. 6 is a flow diagram that illustrates an embodiment of a method for load balancing the raster image processing of a print job;

FIG. 7 is a flow diagram that illustrates an embodiment of a method for supervising access to an RIP unit by a print server that is load balancing the raster image processing of a print job; and

FIG. 8 is a block diagram illustrating the major hardware components typically utilized in a computer system.

### DETAILED DESCRIPTION

Systems and methods for load balancing the creation of raster data and page description language data on a host are disclosed. In accordance with an embodiment, a print server receives a request from the host for instructions regarding how to process graphics commands corresponding to a print job that originates on the host. In response, the print server determines whether raster image processing of the graphics commands is more efficiently performed by a raster image processing unit on the host or by one or more other raster image processing units that are not located on the host. This may involve evaluating one or more factors that affect raster image processing performance, such as host capabilities, printing device capabilities, print server capabilities, the status of the one or more other raster image processing units, raster image processing unit statistics, network capacity, network performance, graphics commands statistics, etc.

If the print server determines that the raster image processing is more efficiently performed by the host's raster image processing unit, the print server instructs the host to rasterize the graphics commands. The print server then receives raster data from the host, and sends the raster data to a printing device.

If the print server determines that the raster image processing is more efficiently performed by the one or more other raster image processing units, the print server instructs the host to render the graphics commands into page description language data. The print server then receives the page description language data from the host, and distributes the raster image processing of the page description language data among the one or more other raster image processing units.

The step of distributing the raster image processing of the page description language data may involve instructing a local raster image processing unit to rasterize at least some of the page description language data. Alternatively, or in addition, the step of distributing the raster image processing of the page description language data may involve sending at least some of the page description language data to one or more other hosts for rasterization. Alternatively, or in addition, the step of distributing the raster image processing of the page description language data may involve sending at least some of the page description language data to one or more side server systems for rasterization. Alternatively, or in addition, the step of distributing the raster image processing of the page description language data may involve sending at least some of the page description language data to a printing device for rasterization.

At least some of the steps described above may be repeated for multiple segments of the print job. Alternatively, however, the steps described above may be performed once for the entire print job.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

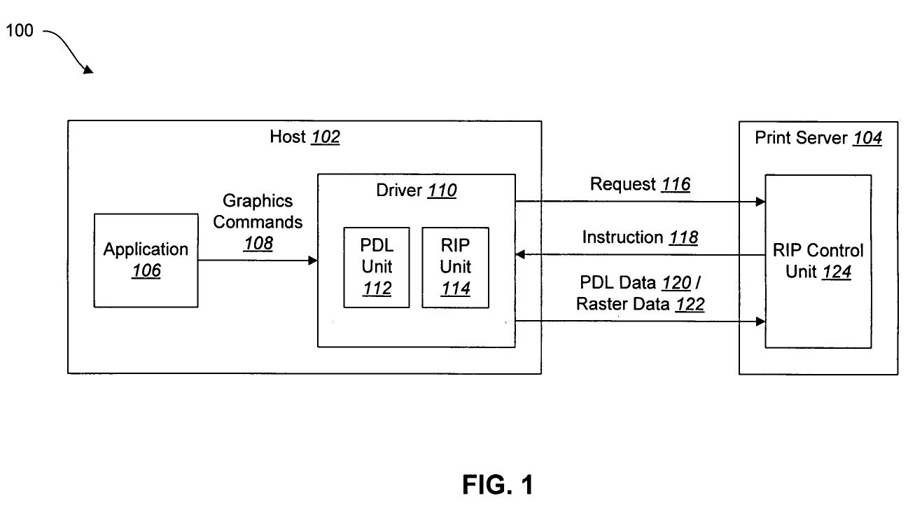

FIG. 1 is a block diagram that illustrates some components in an embodiment of a system 100 for load balancing the raster image processing of a print job. The system 100 of FIG. 1 includes a host 102 that is in electronic communication with a print server 104. The print server 104 is a computer system that is dedicated to managing printing devices on a computer network. The print server 104 may manage print requests and make queue status information available to end users and network administrators.

When an application 106 on the host 102 is instructed to print one or more documents (e.g., by a user, a scheduled task, etc.) on a particular printing device (not shown), the application 106 passes graphics commands 108 for printing the document(s) to a driver 110 for the printing device. In a Microsoft Windows® environment, the application 106 passes graphics device interface (GDI) commands to the operating system, which sends them to the driver 110 in the form of DDI commands.

The driver 110 includes an RIP unit 114. The RIP unit 114 is configured to perform raster image processing. In other words, the RIP unit 114 is configured to convert the graphics commands 108 into raster data 122, which is the matrix of pixels (bitmap) that is ultimately printed on paper by a printing device.

The driver 110 also includes a page description language (PDL) unit 112. The PDL unit 112 is configured to convert the graphics commands 108 into PDL data 120. The PDL data 120 specifies the arrangement of the various elements of the print job. The PDL data 120 may be PostScript data, Printer Command Language (PCL) data, etc.

Before processing the graphics commands 108 for the print job, the driver 110 sends a request 116 to an RIP control unit 124 on the print server 104 for instructions regarding how the graphics commands 108 should be processed. In particular, the driver 110 requests that the RIP control unit 124 determine whether the host 102 should rasterize the graphics commands 108 or render the graphics commands 108 into PDL data 120.

In response to the request 116, the RIP control unit 124 determines whether it would be more efficient for the RIP unit 114 on the host 102 or for another RIP unit that is located elsewhere to rasterize the graphics commands 108. Some factors that may be considered in making this determination will be discussed below.

The RIP control unit 124 responds to the request 116 from the driver 110 with an instruction 118 that indicates how the graphics commands 108 should be processed. In particular, if the RIP control unit 124 determines that it would be more efficient for the RIP unit 114 on the host 102 to rasterize the graphics commands 108, the RIP control unit 124 instructs the driver 110 to rasterize the graphics commands 108. In response, the RIP unit 114 on the host 102 rasterizes the graphics commands 108, thereby generating raster data 122. The raster data 122 is then sent to the print server 104.

In contrast, if the RIP control unit 124 determines that it would be more efficient for another RIP unit to rasterize the graphics commands 108, the RIP control unit 124 instructs the driver 110 to render the graphics commands 108 into PDL data 120. In response to this instruction 118, the PDL unit 112 on the host 102 renders the graphics commands 108 into PDL data 120. The PDL data 120 is then sent to the print server 104.

In some embodiments, the process described above may be performed once for an entire print job. In other words, the RIP control unit 124 may determine how an entire print job should be processed by the driver 110 (i.e., whether the driver 110 should create raster data 122 or PDL data 120). Alternatively, the process described above may be repeated multiple times for a single print job. In particular, the RIP control unit 124 may make a separate determination for different segments of the print job. A segment of a print job may be a page, a page band, etc.

Although a driver 110 is used in the embodiment shown in FIG. 1, in an alternative embodiment a print processor may be used. In such an embodiment, if the driver 110 announces that it is EMF compliant, and if a print processor is included that can process the EMF, then when the application 106 prints, the operating system produces device independent graphics commands, places them into an EMF file, and passes the location of the EMF file to the print processor. The print processor then takes the EMF file and starts processing it immediately. The print processor then interacts with the RIP control unit 124 in a manner similar to that described above in connection with the driver 110.

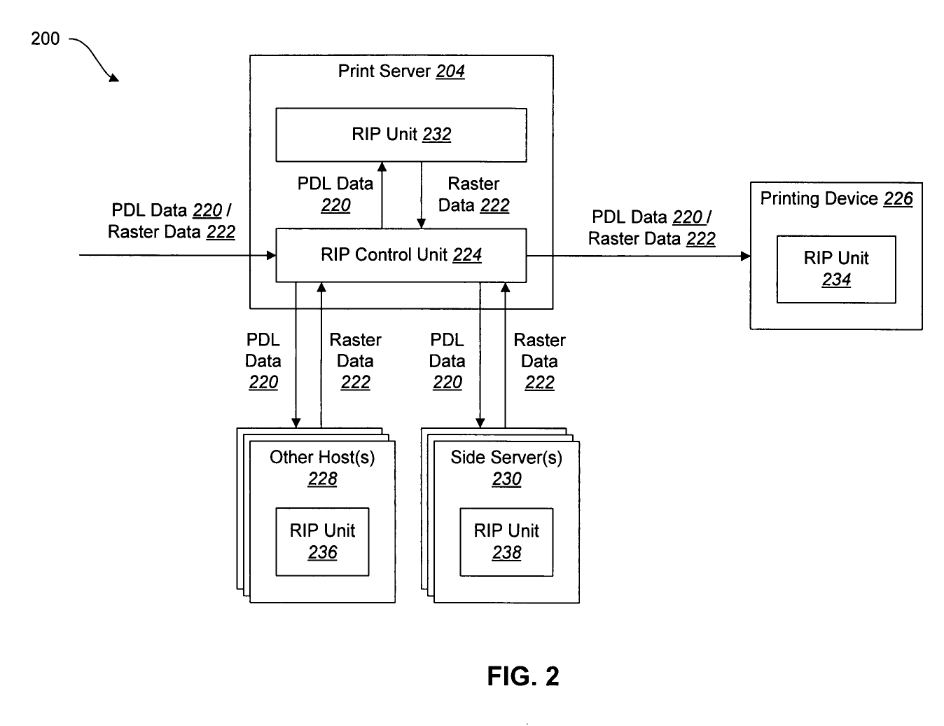

FIG. 2 illustrates the operation of an RIP control unit 224 on a print server 204 in some embodiments. As discussed above, the RIP control unit 224 instructs the driver 110 (or print processor) regarding whether the driver 110 should rasterize graphics commands 108 corresponding to a print job or render the graphics commands 108 into PDL data 220.

If the RIP control unit 224 instructs the driver 110 to rasterize the graphics commands 108, the RIP control unit 224 receives raster data 222 from the host 102. The RIP control unit 224 then sends the raster data 222 to the printing device 226.

If the RIP control unit 224 instructs the driver 110 to render the graphics commands 108 into PDL data 220, the RIP control unit 224 receives PDL data 220 from the host 102. When this occurs, the RIP control unit 224 distributes the raster image processing of the PDL data 220 among one or more available RIP units. In the embodiment shown in FIG. 2, there are several available RIP units. In particular, the print server 204 includes an RIP unit 232. In addition, the print server 204 is in electronic communication with one or more other hosts 228 (i.e., hosts 228 other than the host 102 on which the print job originated). One or more RIP units 236 may be included on these other hosts 228. Additionally still, the print server 204 is in electronic communication with one or more side servers 230. One or more RIP units 238 may be included on these side servers 230. In addition, the printing device 226 may include an RIP unit 234.

Under some circumstances, the RIP control unit 224 may send the PDL data 220 to a single RIP unit for rasterization. For example, the RIP control unit 224 may send the PDL data 220 to the local RIP unit 232, to an RIP unit 236 on one of the other hosts 228, to an RIP unit 238 on one of the side servers 230, or to the RIP unit 234 on the printing device 226.

Alternatively, the RIP control unit 224 may send different portions of the PDL data 220 to different RIP units for rasterization. For example, the RIP control unit 224 may send a portion of the PDL data 220 to the local RIP unit 232, a different portion of the PDL data 220 to one or more RIP units 236 on the other host(s) 228, a different portion of the PDL data 220 to one or more RIP units 238 on the side server(s) 230, and a different portion of the PDL data 220 to the RIP unit 234 on the printing device 226.

When the RIP unit(s) have rasterized the PDL data 220, the raster data 222 may, where appropriate, be sent to the printing device 226. For example, the RIP unit 232 on the print server 204, the RIP unit(s) 236 on the other host(s) 228, and/or the RIP unit(s) 238 on the side server(s) may send raster data 222 to the RIP control unit 224, which may then send the raster data 222 to the printing device 226. The RIP unit 234 on the printing device 226 may provide the raster data 222 that it creates to other components on the printing device 226 that effect printing of the raster data 222.

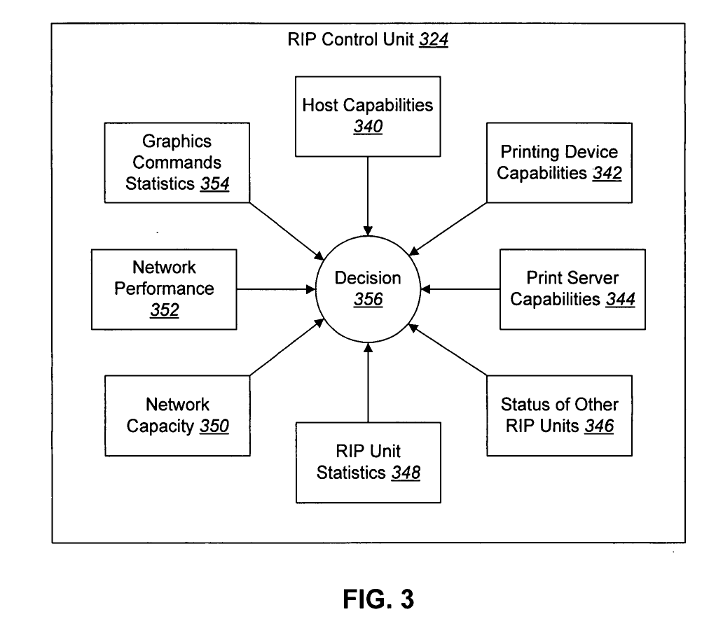

FIG. 3 illustrates some exemplary components and/or information that may be included in and/or utilized by an RIP control unit 324 in some embodiments. As discussed above, the RIP control unit 324 instructs the driver 110 regarding whether the driver 110 should rasterize graphics commands 108 corresponding to a print job or render the graphics commands 108 into PDL data 120. To make this determination, the RIP control unit 324 may include a decision component 356 that evaluates various factors that affect raster image processing performance.

For example, the decision component 356 of the RIP control unit 324 may consider the host capabilities 340, the printing device capabilities 342, and the print server capabilities 344. The capabilities of other devices may be considered as well. For example, the capabilities of any additional host(s) 228 or side server(s) 230 that are available to be utilized may be considered as well.

The RIP control unit 324 may also measure or request information concerning the status 346 of other RIP units. The RIP control unit 324 may also consider RIP unit statistics 348, such as the CPU type, clock speed, memory available for processing, NIC speed, etc.

The RIP control unit 324 may also consider network capacity 350 as well as network performance 352. The stated network capacity 350 may provide a starting point, but the current load on the network may make the actual network performance vary greatly from its capacity. Thus, information concerning the network performance 352 may be used as well.

The RIP control unit 324 may also consider graphics commands statistics 354. When a document contains millions of graphics commands 108 overlapping each other, the burden of transmitting the graphics commands 108 to the print server 204 may be prohibitive. In this case the rasterized image may be smaller, and it may be optimal to rasterize on the host 102. On the other hand, text graphics may be easily sent as PDL data 120.

In some embodiments, only some of the above factors may be considered by the RIP control unit 324. In addition, other factors in addition to those listed above may also be considered. For example, in some embodiments, statistics related to the combination of the graphics commands 108 that are being used and the software that is used to perform rasterization may be considered.

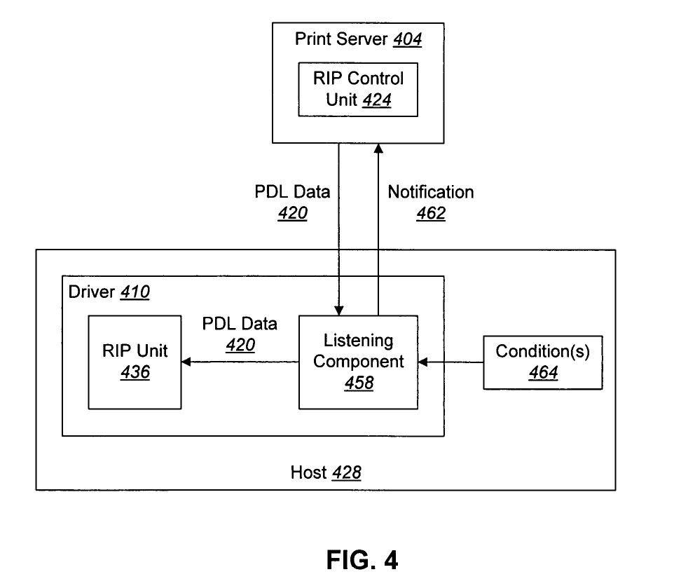

FIG. 4 illustrates some exemplary components that may be included in a host 428 in some embodiments. As discussed above, the RIP control unit 424 on the print server 404 may send PDL data 420 corresponding to a print job to another host 428 for rasterization.

The host 428 may include a driver 410 for the target printing device 226. The driver 410 may include an RIP unit 436. In addition, in the illustrated embodiment a listening component 458 is provided. The listening component 458 is configured to supervise access to the RIP unit 436 on the host 428. The listening component 458 listens for requests from the print server 404 to rasterize PDL data 420. In response to such a request, the listening component 458 determines whether one or more conditions 464 are satisfied for allowing the RIP unit 436 on the host 428 to rasterize the PDL data 420. The condition(s) 464 may relate to the extent to which the CPU of the host 428 is being utilized. For example, if the host 428 is not being utilized, or is not performing a CPU-intensive activity, then the RIP unit 436 may be available to rasterize the PDL data 420.

If the one or more conditions 464 are satisfied, the listening component 458 instructs the RIP unit 436 to rasterize the PDL data 420. However, if the one or more conditions 464 are not satisfied, the listening component 458 sends a notification message 462 to the print server 404 notifying the print server 404 that the RIP unit 436 is not available to rasterize the PDL data 420.

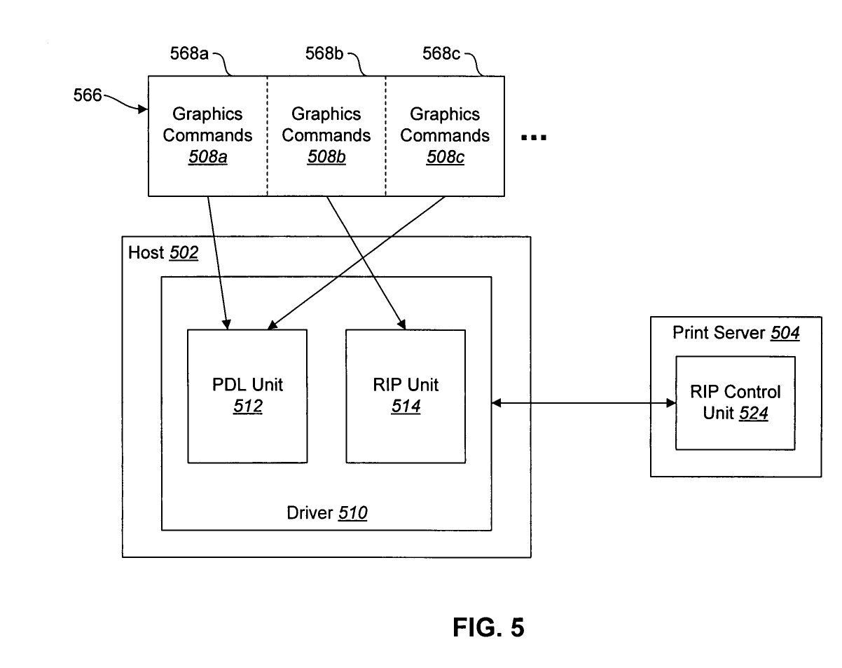

FIG. 5 illustrates how the graphics commands 508 that correspond to a print job 566 may be processed in some embodiments. As discussed above, the RIP control unit 524 instructs the driver 110 regarding whether the driver 110 should rasterize the graphics commands 508 corresponding to a print job or render the graphics commands 508 into PDL data 120.

The print job 566 shown in FIG. 5 includes three segments, a first segment 568a, a second segment 568b, and a third segment 568c. Each segment 568 may correspond to a page, a page band, etc. In the illustrated embodiment, the RIP control unit 524 makes a separate determination for different segments of the print job. Thus, different segments 568 of the same print job 566 may be processed differently. For example, in the illustrated embodiment, the RIP control unit 524 instructs the driver 510 to render the graphics commands 508a, 508c that correspond to the first and third segments 568a, 568c of the print job 566 into PDL data 120. However, the RIP control unit 524 instructs the driver 510 to rasterize the graphics commands 508b that correspond to the second segment 568b of the print job 566.

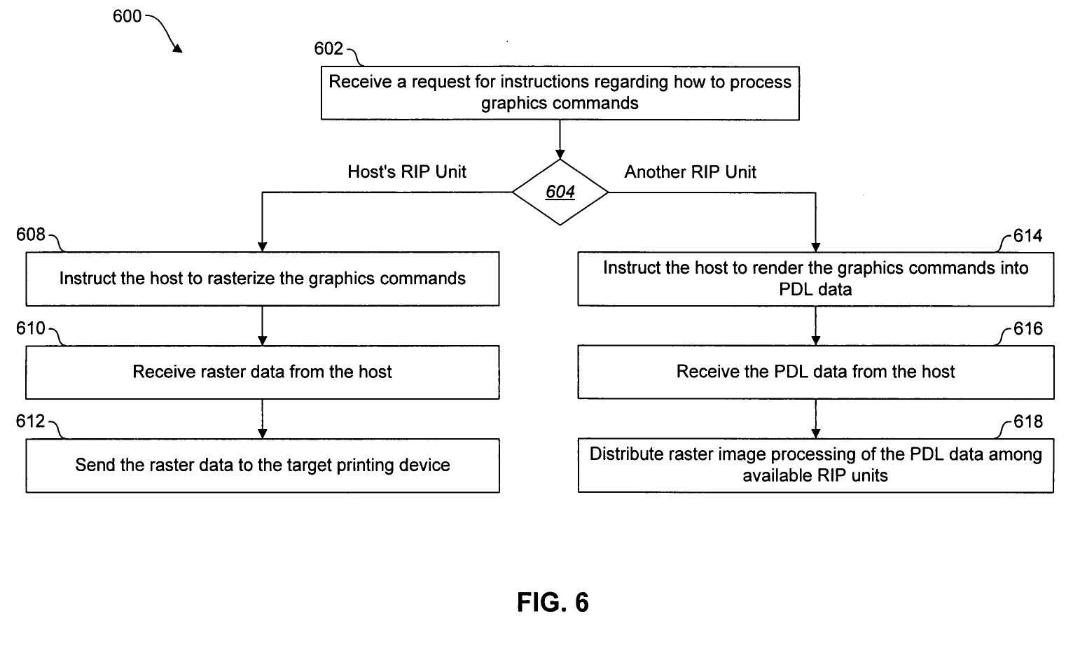

FIG. 6 is a flow diagram that illustrates an embodiment of a method 600 for load balancing the creation of raster data and page description language data on a host 102. The method 600 may be implemented by an RIP control unit 124 on a print server 104.

The method 600 begins when the RIP control unit 124 receives 602 a request 116 from a driver 110 on a host 102 for instructions regarding how to process graphics commands 108 that correspond to a print job. In particular, the driver 110 requests that the RIP control unit 124 determine whether the host 102 should rasterize the graphics commands 108 or render the graphics commands 108 into PDL data 120. The driver 110 may request instructions for an entire print job, or just some segment (e.g., a page, a page band, etc.) of the print job 566.

In response to the request 116, the RIP control unit 124 determines 604 whether it would be more efficient for the RIP unit 114 on the host 102 or for another RIP unit that is located elsewhere to rasterize the graphics commands 108. In determining how the graphics commands 108 should be processed, the RIP control unit 124 may evaluate various factors that affect raster image processing performance, such as host capabilities 340, printing device capabilities 342, print server capabilities 344, the status 346 of other RIP units, RIP unit statistics 348, network capacity 350, network performance 352, graphics commands statistics 354, and so forth.

If the RIP control unit 124 determines 604 that it would be more efficient for the RIP unit 114 on the host 102 to rasterize the graphics commands 108, the RIP control unit 124 instructs 608 the host 102 to rasterize the graphics commands 108. In response, the RIP unit 114 on the host 102 rasterizes the graphics commands 108, thereby generating raster data 122. The RIP control unit 124 receives 610 the raster data 122 from the host 102, and sends 612 the raster data 122 to the target printing device 226.

If the RIP control unit 124 determines 604 that it would be more efficient for another RIP unit to rasterize the graphics commands 108, the RIP control unit 124 instructs 614 the host 102 to render the graphics commands 108 into PDL data 120. In response, the PDL unit 112 on the host 102 renders the graphics commands 108 into PDL data 120, and sends the graphics commands 108 to the RIP control unit 124. The RIP control unit 124 receives 616 the PDL data 120 from the host 102. The RIP control unit 124 then distributes 618 the raster image processing of the PDL data 120 among one or more available RIP units. This may involve sending the PDL data 120, in whole or in part, to a local RIP unit 232, one or more RIP units 236 that are located on other host(s) 228, one or more RIP units 238 that are located on side server(s) 230, and/or an RIP unit 234 that is located on the printing device 226.

In some embodiments, the steps of the method 600 may be performed once for an entire print job. Alternatively, the steps of the method 600 may be repeated multiple times for a single print job, once for each segment of the print job.

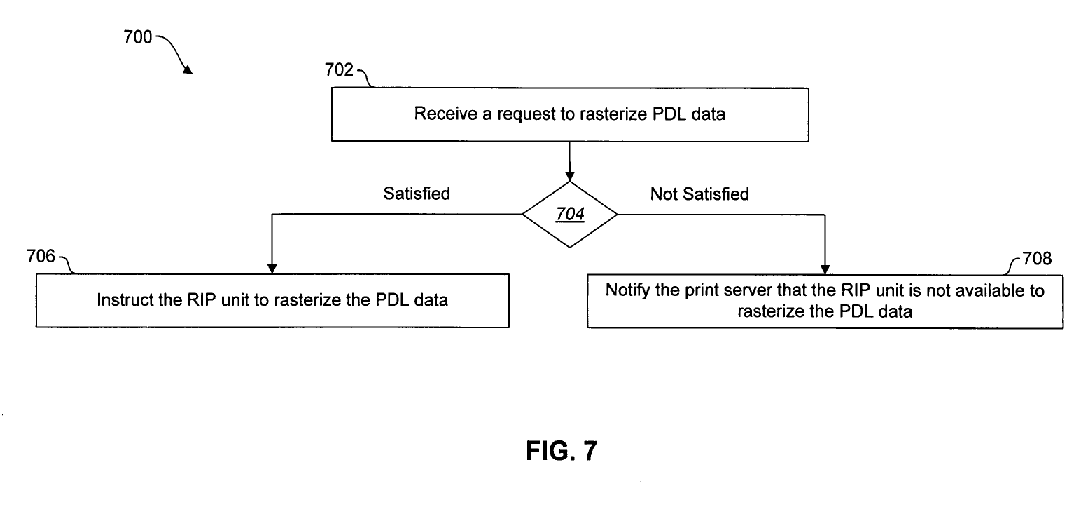

FIG. 7 is a flow diagram that illustrates an embodiment of a method 700 for supervising access to an RIP unit 436 on a host 428 by a print server 404 that is load balancing the creation of raster data and page description language data on a separate host 102. The method 700 may be implemented by a listening component 458 in a printing device driver 410 on the host 428.

The method 700 begins when the listening component 458 receives 702 a request to rasterize PDL data 420. In response to the request, the listening component 458 determines 704 whether one or more conditions 464 are satisfied for allowing the RIP unit 436 on the host 428 to rasterize the PDL data 420. The condition(s) 464 may relate to the extent to which the CPU on the host 428 is being utilized.

If the condition(s) 464 are satisfied, the listening component 458 instructs 706 the RIP unit 436 to rasterize the PDL data 420. However, if the condition(s) 464 are not satisfied, the listening component 458 notifies 708 the print server 404 that the RIP unit 436 is not available to rasterize the PDL data 420.

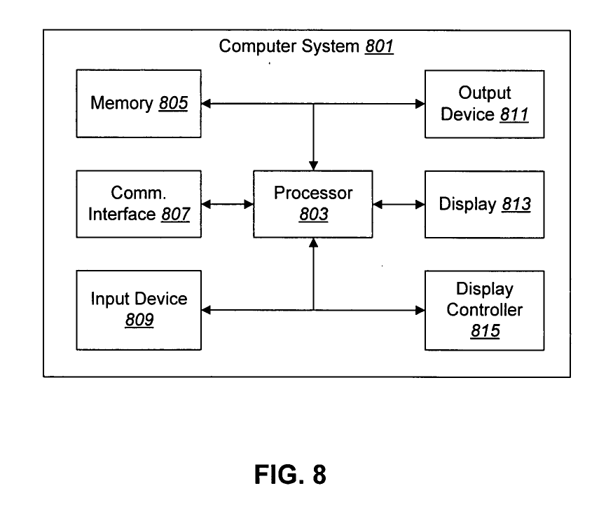

FIG. 8 is a block diagram illustrating the major hardware components typically utilized in a computer system 801. The illustrated components may be located within the same physical structure or in separate housings or structures.

The computer system 801 includes a processor 803 and memory 805. The processor 803 controls the operation of the computer system 801 and may be embodied as a microprocessor, a microcontroller, a digital signal processor (DSP) or other device known in the art. The processor 803 typically performs logical and arithmetic operations based on program instructions stored within the memory 805.

As used herein, the term memory 805 is broadly defined as any electronic component capable of storing electronic information, and may be embodied as read only memory (ROM), random access memory (RAM), magnetic disk storage media, optical storage media, flash memory devices in RAM, on-board memory included with the processor 803, EPROM memory, EEPROM memory, registers, etc. The memory 805 typically stores program instructions and other types of data. The program instructions may be executed by the processor 803 to implement some or all of the methods disclosed herein.

The computer system 801 typically also includes one or more communication interfaces 807 for communicating with other electronic devices. The communication interfaces 807 may be based on wired communication technology, wireless communication technology, or both. Examples of different types of communication interfaces 807 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 801 typically also includes one or more input devices 809 and one or more output devices 811. Examples of different kinds of input devices 809 include a keyboard, mouse, microphone, remote control device, button, joystick, trackball, touchpad, lightpen, etc. Examples of different kinds of output devices 811 include a speaker, printer, etc. One specific type of output device which is typically included in a computer system is a display device 813. Display devices 813 used with embodiments disclosed herein may utilize any suitable image projection technology, such as a cathode ray tube (CRT), liquid crystal display (LCD), light-emitting diode (LED), gas plasma, electroluminescence, or the like. A display controller 815 may also be provided, for converting data stored in the memory 805 into text, graphics, and/or moving images (as appropriate) shown on the display device 813.

Of course, FIG. 8 illustrates only one possible configuration of a computer system 801. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for load balancing the creation of raster data and page description language data on a host, the method being implemented by a print server that is in electronic communication with the host, the method comprising:
determining whether raster image processing of graphics commands corresponding to a print job is more efficiently performed by a raster image processing unit on the host or by one or more other raster image processing units;
if it is determined that the raster image processing is more efficiently performed by the host's raster image processing unit, instructing the host to rasterize the graphics commands; and
if it is determined that the raster image processing is more efficiently performed by the one or more other raster image processing units, instructing the host to render the graphics commands into page description language data.

2. The method of claim 1, wherein if it is determined that the raster image processing is more efficiently performed by the host's raster image processing unit, the method further comprises:
receiving raster data from the host; and
sending the raster data to a printing device.

3. The method of claim 1, wherein if it is determined that the raster image processing is more efficiently performed by the one or more other raster image processing units, the method further comprises:
receiving the page description language data from the host; and
distributing the raster image processing of the page description language data among the one or more other raster image processing units.

4. The method of claim 3, wherein distributing the raster image processing of the page description language data comprises instructing a local raster image processing unit to rasterize at least some of the page description language data.

5. The method of claim 3, wherein distributing the raster image processing of the page description language data comprises sending at least some of the page description language data to one or more other hosts for rasterization.

6. The method of claim 3, wherein distributing the raster image processing of the page description language data comprises sending at least some of the page description language data to one or more side server systems for rasterization.

7. The method of claim 3, wherein distributing the raster image processing of the page description language data comprises sending at least some of the page description language data to a printing device for rasterization.

8. The method of claim 1, wherein the steps of the method are repeated for multiple segments of the print job.

9. The method of claim 1, wherein the steps of the method are performed once for the entire print job.

10. The method of claim 1, further comprising receiving a request from the host for instructions regarding how to process the graphics commands.

11. The method of claim 10, wherein the step of determining whether the raster image processing is more efficiently performed by the host's raster image processing unit or by the one or more other raster image processing units is performed in response to receiving the request.

12. The method of claim 1, wherein the step of determining whether the raster image processing is more efficiently performed by the host's raster image processing unit or by the one or more other raster image processing units comprises evaluating one or more factors that affect raster image processing performance.

13. The method of claim 12, wherein the one or more factors are selected from the group consisting of host capabilities, printing device capabilities, print server capabilities, status of the one or more other raster image processing units, raster image processing unit statistics, network capacity, network performance, and graphics commands statistics.

14. The method of claim 1, wherein the print job originates on the host.

15. The method of claim 1, wherein the one or more other raster image processing units are not located on the host.

16. The method of claim 1, wherein at least one of the one or more other raster image processing units is located on the print server.

17. The method of claim 1, wherein at least one of the one or more other raster image processing units is located on a side server.

18. The method of claim 1, wherein at least one of the one or more other raster image processing units is located on a separate host.

19. A print server that is configured to implement a method for load balancing the creation of raster data and page description language data on a host, the computer system comprising:
a processor;
memory in electronic communication with the processor;
instructions stored in the memory, the instructions being executable to implement a method comprising:
determining whether raster image processing of graphics commands corresponding to a print job is more efficiently performed by a raster image processing unit on the host or by one or more other raster image processing units;
if it is determined that the raster image processing is more efficiently performed by the host's raster image processing unit, instructing the host to rasterize the graphics commands; and
if it is determined that the raster image processing is more efficiently performed by the one or more other raster image processing units, instructing the host to render the graphics commands into page description language data.

20. A computer-readable medium comprising executable instructions for implementing a method for load balancing the creation of raster data and page description language data on a host, the method being implemented by a print server that is in electronic communication with the host, the method comprising:
determining whether raster image processing of graphics commands corresponding to a print job is more efficiently performed by a raster image processing unit on the host or by one or more other raster image processing units;
if it is determined that the raster image processing is more efficiently performed by the host's raster image processing unit, instructing the host to rasterize the graphics commands; and
if it is determined that the raster image processing is more efficiently performed by the one or more other raster image processing units, instructing the host to render the graphics commands into page description language data.
